(19) United States
(12) Patent Application Publication
(10) Pub. No.: US 2005/0078362 A1
(43) Pub. Date: Apr. 14, 2005

(54) Microscope

(75) Inventor: Rolf Borlinghaus, Dielheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Heidelberg GmbH, Mannheim (DE)

(21) Appl. No.: 10/961,176

(22) Filed: Oct. 8, 2004

(30) Foreign Application Priority Data
Oct. 11, 2003 (DE) DE 103 47 326.2

(51) Int. Cl. G02B 21/06

(52) U.S. Cl. 359/385; 359/368

(57) ABSTRACT

A microscope contains a light source that emits illuminating light, and an apparatus that generates an illumination pattern in an image field of the microscope. The illumination patterns serves for photochemical modification of the sample.

### CROSS REFERENCE TO RELATED APPLICATIONS

This application claims priority to German patent application 103 47 326.2, the subject matter of which is hereby incorporated by reference herein.

### FIELD OF THE INVENTION

The invention concerns a module for connection to a microscope.

### BACKGROUND OF THE INVENTION

For many microscopic experiments, it is essential to manipulate the sample, for example, photochemically. In cell biology, samples are often prepared with compounds that contain calcium or amino acids such as glutamate. These “caged” compounds are made up on the one hand of the “caged” calcium or glutamate, and on the other hand of the so-called complex formers or gelators. These compounds can be dissociated by irradiation with UV light or by means of two-photon processes, this being referred to as “photoactivation.” The calcium or glutamate that is released is then capable of initiating further reactions.

Unexamined Application DE 100 43 986 Al discloses a confocal scanning microscope and a method for investigating a sample. The confocal scanning microscope comprises a light source, preferably a laser, for generating an illuminating light beam, and a beam deflection device for guiding the illuminating light beam over the sample. Means for acquiring a preview image, and means for marking at least one region of interest in the preview image, are provided, such that individual illumination light beam wavelengths and/or illumination light beam power levels are assignable to the region or regions and the region or regions of the sample can be illuminated in accordance with the assignment, and at least one manipulation in at least one region is performable by means of the illumination.

In scanning microscopy, a sample is illuminated with a light beam in order to observe the reflected or emitted fluorescent light proceeding from the specimen. The focus of an illuminating light beam is moved in a specimen plane by means of a controllable beam deflection device, generally by tilting two mirrors, the deflection axes usually being perpendicular to one another so that one mirror deflects in the X direction and the other in the Y direction. Tilting of the mirrors is brought about, for example, by means of galvanometer positioning elements. The power level of the light coming from the specimen is measured as a function of the position of the scanning beam. The positioning elements are usually equipped with sensors to ascertain the present mirror position.

In confocal scanning microscopy specifically, a specimen is scanned in three dimensions with the focus of a light beam. A confocal scanning microscope generally comprises a light source, a focusing optical system with which the light of the source is focused onto an aperture (called the “excitation pinhole”), a beam splitter, a beam deflection device for beam control, a microscope optical system, a detection pinhole, and the detectors for detecting the detected or fluorescent light. The illuminating light is coupled in via a beam splitter. The fluorescent or reflected light coming from the specimen travels back via the beam deflection device to the beam splitter, traverses it, and is then focused onto the detection pinhole behind which the detectors are located. Detected light that does not derive directly from the focus region in the specimen takes a different light path and does not pass through the detection pinhole, so that information is obtained only from the focus region and results, by sequential scanning of the specimen, in a three-dimensional image. A three-dimensional image is usually achieved by acquiring image data in layers, the path of the scanning light beam on or in the specimen ideally describing a meander. To make possible acquisition of image data in layers, the sample stage or the objective is shifted after a layer is scanned, and the next layer to be scanned is thus brought into the focal plane of the objective.

### SUMMARY OF THE INVENTION

It is an object of the present invention to provide a universal capability, adaptable to specific experimentation conditions, for photochemical modification of a sample.

The present invention provides a module for connection to a microscope comprising: a light source that emits illuminating light, an apparatus that generates, in an image field of the microscope, an illumination pattern that photochemically modifies a sample.

The invention has the advantage that the module can be embodied adaptably for connection to any microscope. The module can moreover be equipped with a wide variety of light sources or apparatuses for generating an illumination pattern, thus making possible universal adaptation to specific experimentation conditions.

In an embodiment, the light source contains a halogen lamp. In another variant, a high-pressure lamp, in particular a high-pressure mercury lamp, is provided as the light source. In an embodiment, the light source contains at least one laser that can be embodied, for example, as a multi-line laser.

For generation of an illumination pattern, a beam deflection device that is embodied, for example, on the basis of galvanometer mirrors can preferably be provided. In another variant, rotatably arranged prisms are provided for guidance of the illuminating light. In the aforesaid embodiments, the illumination pattern in the sample is generated by controlled guidance of the illuminating light along predefined illumination tracks.

In another variant, the illumination pattern is projected into the sample. The apparatus that generates an illumination pattern in an image field of the microscope preferably contains, for that purpose, an LCD element or a micromirror device (MMD).

The illuminating light pattern can encompass a spot pattern, a line pattern, a delimited surface portion, or a volume.

In an embodiment, means for varying the light power level of the illuminating light are provided. The light power level of the illuminating light is preferably modifiable during travel along an illumination track. The means for varying the light power level preferably contains an acoustooptical component that can be embodied, for example, as an acoustooptical tunable filter (AOTF). In another variant, the means for varying the light power level contains an electrooptical component.

When the boundary conditions of the experiment require it, the illumination pattern can comprise subregions having different illuminating light intensities.

In an embodiment, the microscope to which the module is connectable is a scanning microscope or a confocal scanning microscope.

The microscope preferably comprises a stand having a port through which the illuminating light of the light source can be incoupled. In an advantageous variant, an alignment device is provided for aligning the beam path of the illuminating light. This alignment apparatus preferably operates automatically.

In a variant, the photochemical modification of the sample encompasses a bleaching of the sample. In another variant, the photochemical modification encompasses an activation or deactivation of a sample dye. In another variant, the photochemical modification encompasses a release of previously bound substances.

The illumination pattern is preferably defined by the user. For that purpose, firstly a preview image can be acquired by the fact that the user can define, for example using a pointing device (computer mouse), the regions to be covered by the illumination pattern. Provision can also be made for the regions to be impinged upon by the illumination pattern to be automatically defined, for example by an image evaluation software program.

### BRIEF DESCRIPTION OF THE DRAWINGS

The subject matter of the invention is schematically depicted in the drawings and will be described below with reference to the Figures, identically functioning elements being labeled with the same reference characters. In the drawings:

FIG. 1 shows a microscope having a module according to the present invention connected to it.

### DETAILED DESCRIPTION OF THE INVENTION

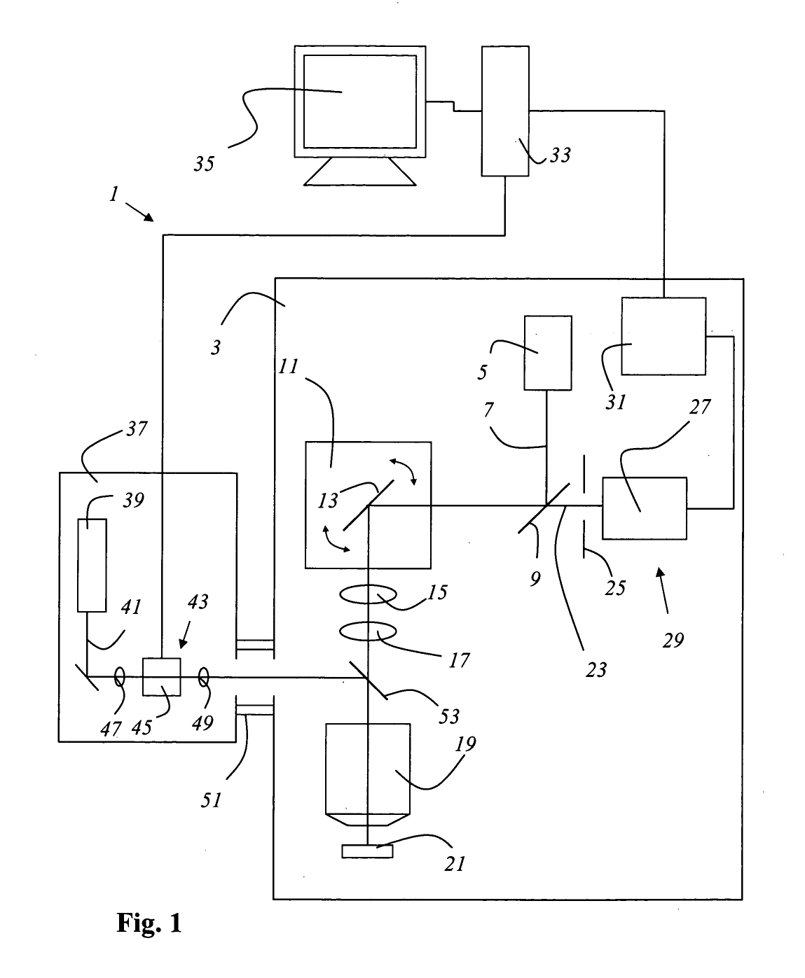

FIG. 1 shows a microscope 1 that is embodied as a scanning microscope 3. Scanning microscope 3 contains a laser 5 that generates a scanning light beam 7. Scanning light beam 7 is directed from main beam splitter 9 to a scanning device 11 that contains a gimbal-mounted scanning mirror 13. Gimbal-mounted scanning mirror 13 guides scanning light beam 7 through scanning optical system 15, tube optical system 17 and, through microscope objective 19, over or through sample 21. Detected light 23 proceeding from sample 21 travels along the opposite light path, namely through objective 19, tube optical system 17, scanning optical system 15, and via gimbal-mounted scanning mirror 13 back to main beam splitter 9, traverses the latter and the subsequent detection pinhole 25, and then arrives at detector 29 embodied as photomultiplier 27. Detector 29 generates electrical detected signals proportional to the power level of detected light 23, which are forwarded to processing unit 31. Processing unit 31 associates the acquired data with the position data of scanning device 11 and constitutes therefrom image data that are conveyed to a PC 33 on whose monitor 35 an image of the sample is displayed.

Connected to scanning microscope 3 is a module 37 having a light source 39 that emits illuminating light 41, and having an apparatus 43 that generates, in an image field of scanning microscope 3, an illumination pattern for photochemical modification of the sample. The apparatus for generating an illumination pattern contains an LCD element 45 that modifies the pattern of the illuminating light in accordance with the user's specifications. The user makes his or her settings for this purpose via PC 33. The apparatus for generating the illumination pattern contains two optical systems 47 and 49 for achieving optimum imaging of the illumination pattern in the image field of sample 21, module 37 being easily connectable to the stand of the scanning microscope via connection mechanism 51. Incoupling of illuminating light 41 occurs in the scanning microscope via a beam splitter 53 that is designed in such a way that it reflects the illuminating light and simultaneously allows light of the wavelength of the scanning light beam, and light of the wavelength of the detected light, to pass.

The invention has been described with reference to a particular embodiment. It is self-evident, however, that changes and modifications can be made without thereby leaving the range of protection of the claims below.

1. A module for connection to a microscope comprising: a light source that emits illuminating light, an apparatus that generates, in an image field of the microscope, an illumination pattern that photochemically modifies a sample.

2. The module as defined in claim 1, wherein the light source comprises a halogen lamp and/or a high-pressure lamp, in particular a high-pressure mercury lamp and/or a laser.

3. The module as defined in claim 1, comprising a beam deflection device.

4. The module as defined in claim 3, wherein the beam deflection device comprises at least one galvanometer mirror and/or at least one rotatably arranged prism.

5. The module as defined in claim 1, comprising an LCD element.

6. The module as defined in claim 1, comprising a micromirror device (MMD).

7. The module as defined in claim 1, wherein the illuminating light pattern encompasses a spot pattern and/or a line pattern and/or a delimited surface portion and/or a volume.

8. The module as defined in claim 1, further comprising a means for varying the light power level of the illuminating light.

9. The module as defined in claim 8, wherein the means for varying the light power level comprises an acoustooptical component, in particular an AOTF, or an electrooptical component.

10. The module as defined in claim 1, wherein the illuminating light pattern comprises different subregions having different illuminating light intensities.

11. The module as defined in claim 1, wherein the microscope is a scanning microscope or a confocal scanning microscope.

12. The module as defined in claim 1, wherein the microscope comprises a stand having a port through which the illuminating light of the light source can be incoupled.

13. The module as defined in claim 1, wherein an alignment device is provided for aligning the beam path of the illuminating light.

14. The module as defined in claim 13, wherein the alignment device operates automatically.

15. The module as defined in claim 1, wherein the photochemical modification encompasses a bleaching and/or an activation of a sample dye and/or a deactivation of a sample dye and/or a release of previously bound substances.

16. A microscope comprising: a light source that emits illuminating light, an apparatus that generates, in an image field of the microscope, an illumination pattern that photochemically modifies a sample.

17. The microscope as defined in claim 16, wherein the light source comprises a halogen lamp and/or a high-pressure lamp, in particular a high-pressure mercury lamp and/or a laser.

18. The microscope as defined in claim 16, further comprising: a means for varying the light power level of the illuminating light.

19. The microscope as defined in claim 16, wherein the photochemical modification encompasses a bleaching and/or an activation of a sample dye and/or a deactivation of a sample dye and/or a release of previously bound substances.
